(19) United States
(12) Patent Application Publication
(10) Pub. No.: US 2005/0207153 A1
(43) Pub. Date: Sep. 22, 2005

(54) Signalling device for automobiles

(76) Inventors: Joel Leleve, Bobigny (FR); Pierre Albou, Bobigny (FR)

Correspondence Address: MORGAN & FINNEGAN, L.L.P., 3 WORLD FINANCIAL CENTER, NEW YORK, NY, 10281-2101, US

(21) Appl. No.: 11/082,134

(22) Filed: Mar. 16, 2005

(30) Foreign Application Priority Data
Mar. 16, 2004 (FR) 0402727

(51) Int. Cl. F21V 9/00

(52) U.S. Cl. 362/231; 362/230; 362/800

(57) ABSTRACT

The invention concerns a signaling device for automobiles, comprising at least one light source and at least one support piece for an optically active zone or zones intended to be illuminated by said light source. The source is a source of light at a first wavelength or first range of wavelengths, and the active zones are zones converting at least part of this light at a first wavelength or range of wavelengths into light at the second wavelength or range of wavelengths in the visible range.

### FIELD OF THE INVENTION

The invention concerns a signaling device for automobiles.

### BACKGROUND OF THE INVENTION

It is known from patent document EP 1 359 369 how to produce a signaling device comprising a light source, preferably a light emitting diode, and a light guide comprising a light entry surface for the light transmitted by this source and a light exit surface. Advantageously, the light sources are disposed on one edge of the light guide. The light guide is printed with dispersible zones formed from a printable colored matrix and dispersive particles included in this matrix. The dispersive particles included can comprise titanium dioxide.

Such an arrangement requires a relatively precise mounting in order to dispose the diodes of the light guide correctly.

Moreover, a relatively large number of light emitting diodes are necessary, which complicates the mounting and is expensive. This line of diodes also creates a visible line of light outside the vehicle.

Finally, the light guide must be produced from specific material and is susceptible to undesirable optical effects, of the prism type.

### SUMMARY OF THE INVENTION

To resolve these problems, the invention proposes a signaling device for automobiles, comprising at least one light source and at least one support piece for an optically active zone or zones intended to be illuminated by said light source. Said source is a source of light at a first wavelength or first range of wavelengths, and said zones are zones converting at least part of this light at the first wavelength or range of wavelengths into light of a second wavelength or range of wavelengths in the visible range.

According to a first embodiment, the light source emits radiation outside the visible range, in particular in the ultraviolet, preferably in the near ultraviolet. And the active zone or zones, advantageously having a fluorescence property, convert this non-visible radiation into radiation in the visible range. In this case, it is not necessary to “conceal” the radiation from the source so that it cannot be seen, once the device of the invention is mounted in a vehicle, since this radiation is invisible to the eye.

According to a second embodiment, the light source emits in the blue or blue-green range, and the active zones are able to convert this light into light with a required wavelength, in the white range generally. It may a case in particular of fluorescent coatings comprising gallium nitride. In this case, it is then generally necessary to provide a configuration of the source such that it is concealed, once the device is mounted in the vehicle.

Generally, it is sought for the color of the light converted by the active zones to be white.

By virtue of the invention, the only constraint is that the light source illuminates said piece. It can then be disposed close to said support piece very freely and can easily be housed at a location not visible from the outside or from the automobile.

Moreover, said source must preferably illuminate only said active zones in order to fulfill the signaling function. The invention therefore limits energy losses.

According to a preferred embodiment, said source is a source of UV light and said zones are fluorescent zones. An example of appropriate UV light source is a diode or a plurality of diodes emitting principally or essentially UV rays. But other kinds of diodes can also be used, notably diodes emitting not only UV rays but also rays of another wave length (notably visible rays).

One can therefore use any light sources emitting UV rays and rays of other wavelengths, and use for the purpose of the invention only the UV rays emitted.

The advantage of using fluorescent zones, rather than another luminophore zone, is to obtain a spontaneous illumination effect without remanence.

According to a first variant, said zones comprise coatings, in particular consisting of a varnish or paint and disposed on at least part of the surface of said piece. It is possible to deposit the coating in particular by manufacturing it in situ by coating, spraying, or fixing a prefabricated cladding to the piece, by adhesive bonding for example. The deposition may cover a continuous or discontinuous surface.

According to a second variant, said zones are formed from particles integrated in said piece, which is preferably based on polymer or polymers.

Said zones are preferably in the form of patterns.

By virtue of the invention, it is possible to give the required form to these patterns, which allows innovative effects.

Said support piece may be a light guide comprising a light entry surface for the light transmitted by said source and a light exit surface.

The invention also concerns an automobile headlamp provided with a signaling device as specified above. Said piece may be integral with the reflector and/or form part of the mask of the light or of a wall of the housing of said light, or any other element forming part of the headlamp or which is added to the light in order to implement the invention.

Either one or more pieces are added to the headlamp, which is functionalized with one or more “active” zones within the meaning of the invention, in particular fluorescent, or the piece already forms an integral part of the headlamp (mask, light guide, neutral zone of the reflector, etc), and a second functionality is conferred on it with the addition of active zones within the meaning of the invention.

Said signaling device may form part of an illuminating device of the headlamp.

The device according to the invention may in fact be a light emission supplement associated with an illuminating device, for example a dipped/low beam headlight.

The invention is described below in more detail with the help of figures representing preferred embodiments of the invention.

### BRIEF DESCRIPTION OF THE DRAWINGS

FIG. 1 is a view in schematic vertical section of an automobile headlamp provided with a signaling device according to the invention.

FIG. 2 is a view in schematic vertical section of a signaling device according to a variant in accordance with the invention.

### DESCRIPTION OF THE PREFERRED EMBODIMENTS

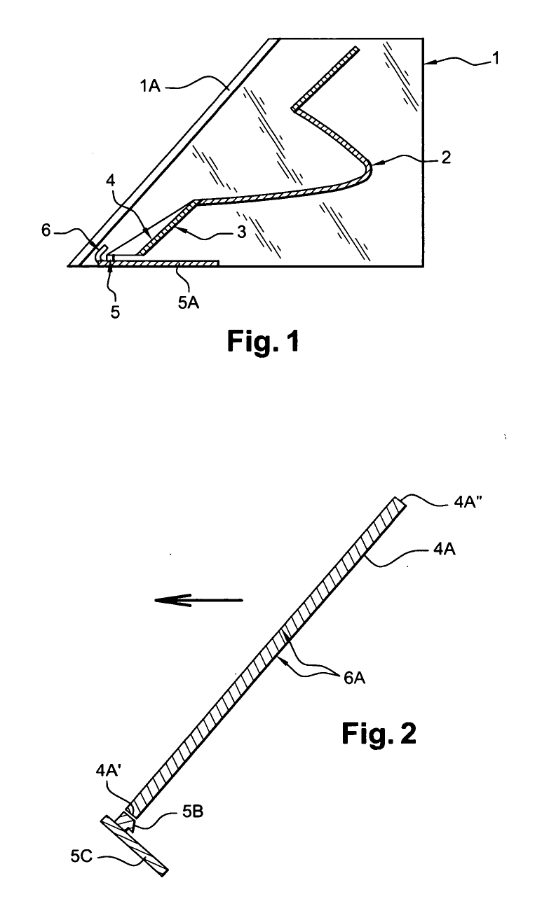

FIG. 1 depicts schematically an automobile light. This light comprises, in a housing 1 closed off by a glass 1A, a reflector 2. A piece 3 is integral with the reflector 2 and is covered on its surface 4 with a fluorescent paint or fluorescent varnish.

A source of UV light, more precisely a UV diode 5 provided with a control circuit 5A, is also disposed in the housing and is concealed from view from outside the automobile by trim 6. The figure depicts the light beam emitted by the diode 5.

When the diode 5 is actuated, the latter illuminates the surface 4 of the support plate 3. The UV wavelength is transformed thereon into a visible wavelength of white light. There then appears, through the glass 1A, an area of visible white light forming a signaling device of the sidelight type.

According to a variant embodiment of the signaling device depicted in FIG. 1, the piece 4A is a transparent sheet forming a light guide and the UV diode 5B with its associated control circuit 5C is disposed so as to transmit light from an entry face 4A′ to an exit face 4A″. These two surfaces are two opposite edges of the plate 4A. On at least one of the faces 6 of the plate there are produced optically active zones, by the application of a transparent fluorescent paint or a transparent fluorescent varnish, which emit white light when the diode 5B is switched on.

According to the examples described above, the source is a source of UV light and the optically active zones are fluorescent zones.

However, the invention applies to any source of light at a first wavelength associated with zones transforming this light at a first wavelength into light of a second visible wavelength, in particular in the white range.

By way of example, it is also possible to use a blue light source associated with zones of luminophore material based on phosphorus.

The support piece can be partially coated with fluorescent paint in optically active zones forming varied patterns (pictorial, graphical). It is possible to use active zones repeating the contours of a logo, a trade mark for example.

These active zones can also be formed from fluorescent particles integrated/dispersed in the piece, which is preferably made from polymer material, transparent, translucent or opaque.

The signaling device according to the invention can be used to form a signaling light, for example a sidelight, as before.

It can also be used for displaying verbal or pictorial information.

It can also form part of an illuminating device for an headlamp, supplementing illumination of the dipped/low beam type. For example, the support piece can be transparent in this case and be placed in front of the illuminating device. When light is emitted by the source according to the invention, an active zone emits visible light, reinforcing or supplementing the light emitted by the illuminating device, in particular a light beam of the dipped type, fixed or dynamic bending light (“Dynamic Bending Light” and “Fixed Bending Light” in English), or a town light beam of the Day Running Light type, or DRL in English.

1. A signalling device for an automobile, comprising
at least one light source and
at least one piece supporting at least one optically active zone intended to be illuminated by said light source,
said source being a source of light at a first wavelength or first range of wavelengths, and said zone being adapted to convert at least part of this light at a first wavelength or a range of wavelengths into light at the second wavelength or range of wavelengths in the visible range.

2. A device as claimed in claim 1, wherein said source is a source of UV light, and said zones are fluorescent zones.

3. A device as claimed in claim 1, wherein said source is at least one diode, emitting principally UV rays.

4. A device as claimed in claim 1, wherein said zones comprise coatings disposed on at least part of a surface of said piece.

5. A device as claimed in claim 1, wherein said zones comprise particles integrated/dispersed in said piece

6. A device as claimed in claim 1, wherein said zones are in the form of patterns.

7. A device as claimed in claim 1, wherein said support piece is a light guide comprising a light entry surface for the light transmitted by said source and a light exit surface.

8. An automobile headlamp provided with a signalling device in accordance with claim 1.

9. An automobile headlamp as claimed in claim 8, comprising a reflector, said piece being integral with the reflector.

10. An automobile headlamp as claimed in claim 8, wherein said signalling device forms part of a lighting module of the headlamp.

11. A vehicle equipped with at least one device as claimed in claim 1.

12. A device as claimed in claim 1, wherein said source is a source of light in the blue or blue-green range, and said zones are fluorescent zones.

13. A device as claimed in claim 4, wherein said coatings consisting of a varnish or a paint.

14. A device as claimed in claim 5, wherein said particles integrated/dispersed in said piece are based on at least one polymer.

15. A device as claimed in claim 6, wherein said patterns are pictorial or graphical.

16. An automobile headlamp as claimed in claim 9, further comprising a mask, said piece forming a part of the mask.

17. A vehicle equipped with an automobile headlamp according to claim 8.
